(19) United States
(12) Patent Application Publication
(10) Pub. No.: US 2026/0103414 A1
(43) Pub. Date: Apr. 16, 2026

(54) SULPHATE REMOVAL USING FLUIDIZED BED REACTOR

(71) Applicant: IDE WATER TECHNOLOGIES LTD., Kadima (IL)

(72) Inventors: Alex DRAK, Kadima (IL); Tomer EFRAT, Kadima (IL); Roi ZAKEN, Kadima (IL)

(21) Appl. No.: 19/256,348

(22) Filed: Jul. 1, 2025

Related U.S. Application Data
(63) Continuation-in-part of application No. PCT/IB2024/050164, filed on Jan. 8, 2024.
(60) Provisional application No. 63/668,404, filed on Jul. 8, 2024.

(30) Foreign Application Priority Data
Jan. 10, 2023 (GB) 2300360.1

(51) Int. Cl. C02F 1/52; C02F 101/10

(52) U.S. Cl. CPC C02F 1/5245; C02F 1/5281; C02F 2001/5218; C02F 2101/101; C02F 2301/046; C02F 2303/22

(57) ABSTRACT

A process for treating fluids for the removal of sulphate therefrom, the process comprising passing a fluid containing a sulphate and carbonate through a fluidized bed reactor; and, loading sulphate to said fluidized bed reactor at a rate that is greater than 1 kg of sulphate per square metre of said fluidized bed reactor per hour (kg SO₄/m²/hr); thereby co-precipitating the sulphate and carbonate. The process must maintain the supersaturation levels of calcium sulphate within a predefined range of 100-450% and provides a loading rate of sulphate in the reactor that is greater than 1 kg of sulphate per square metre of reactor per hour (kg SO₄/m²/hr).

### CROSS-REFERENCES TO RELATED APPLICATIONS

The present application is a continuation-in-part of International Application No. PCT/IB2024/050164, filed on Jan. 8, 2024, which claims priority to British Patent Application No.: 2300360.1 filed on Jan. 10, 2023, the contents of each of which are hereby incorporated in their entireties by reference.

### TECHNICAL FIELD OF THE INVENTION

Sulphate removal from wastewater is a major challenge. It is normally done by precipitation (also refers to as crystallization) as barium sulphate (barite), calcium sulphate (gypsum) or calcium aluminium sulphate (ettringite). The simplest prior art technology for sulphate reduction in mining applications is precipitation of sulphate as calcium sulphate by the addition of lime, with the sulphate concentration being reduced close to a saturation limit of 1,500-2000 mg/L. The precipitation process is very time-consuming, generally taking in excess of 2 hours, requires high volume tanks and produces low density sludge for dewatering. Such low-density sludge is difficult to thicken and filter out.

It is desirable to develop a new process for the removal of sulphate from wastewater which is faster, requires a smaller reactor and removes the need for dewatering.

It is an aim of the present invention is to provide an improved process for the removal of sulphate from fluids, in particular water, that overcomes or at least alleviates the abovementioned drawbacks.

### SUMMARY OF THE INVENTION

A first aspect of the present invention provides an improved process for treating fluids for the removal of sulphate therefrom, the process comprising passing a fluid comprising at least one selected from a group consisting of at least one sulphate-based compound or composition, at least one carbonate-based composition and any combination thereof through a fluidized bed reactor; and, loading sulphate to said fluidized bed reactor at a rate that is greater than 1 kg of sulphate per square metre of said fluidized bed reactor per hour (kg SO4/m2/hr); thereby co-precipitating the sulphate and carbonate.

Optionally, the process comprises a step of periodically removing the crystallized solids from the reactor; wherein the crystallized solids characterized by having minimal average size of at least 300 micro-meter are periodically removed.

The fluid is preferably water, more preferably wastewater, such as industrial wastewater.

The process of the present invention preferably provides a loading rate of sulphate in the reactor greater than 1 kg of sulphate per square metre of reactor per hour (kg SO₄/m²/hr).

According to another embodiment, the loading rate of sulphate in the reactor is greater than 10 kg of sulphate per square metre of reactor per hour (kg SO₄/m²/hr), more preferably greater than 25 kg of sulphate per square metre of reactor per hour (SO₄/m²/hr), especially being at least 30 kg of sulphate per square metre of reactor per hour (SO₄/m²/hr).

According to another embodiment, the process provides a maximum loading rate of sulphate in the reactor of 40 kg of sulphate per square metre of reactor per hour (kg SO₄/m²/hr).

The precipitated sulphate is preferably calcium sulphate. The carbonate preferably comprises calcium carbonate. However, it should be pointed out that sodium sulphate is also possible.

According to another embodiment, the loading sulphate could be sourced from sodium sulphate and/or hydrogen sulphate, H₂SO₄ and/or other sulphate salts and/or mixtures thereof.

Preferably, the supersaturation level of the calcium sulphate is maintained between 100%-450% and a logarithm of the calcium carbonate levels is maintained at 0-2.2. Preferably, the fluid flow velocity through the reactor is at least 40 m/hr (preferably about 20-about 120 m/hr).

The ratio of precipitated calcium carbonate to precipitated calcium sulphate is preferably at least 0.01 (1 to 10) on a mass-base. It may be higher than 1 to 10 (0.1), for example 2 to 10 (0.2), 5 to 10 (0.5) or higher.

In order to keep the required ratio between calcium carbonate and calcium sulphate and in order to precipitate the required amount of sulphate, an external source of calcium or carbonate may be added to the reactor. The required source and the required quantity are determined based on the composition of water to be treated. The source of calcium can be calcium hydroxide, Calcium Chloride, CaCl2 and other salts. The source of carbonate can be sodium carbonate, carbon dioxide, CO2.

According to another embodiment, there is no need for external source of calcium. Carbonates can be added by means of pH increase. As the feed fluid (entering the reactor) contains bicarbonates, increase of the pH will convert the bicarbonates to carbonates.

According to another embodiment, the loading sulphate could be sourced from sodium sulphate and/or hydrogen sulphate, H₂SO₄ and/or other sulphate salts and/or mixtures thereof.

In order to control crystallization process of calcium sulphate and calcium carbonate on the pellets in the reactor, anti-scalant may be added to the fluid. The process may further comprise recycling the fluid back through the fluidized bed reactor.

According to a second aspect of the present invention, there is provided a fluidized bed reactor for the removal of sulphate from fluids, comprising
a. at least one inlet conduit for delivering a fluid comprising at least one selected from a group consisting of at least one sulphate-based compound or composition, at least one carbonate-based composition and any combination thereof; and,
b. at least one loading conduit for loading sulphate-based compound to said fluidized bed reactor;

wherein said sulphate is loaded into said at least one loading conduit at a loading rate that is greater than 1 kg of sulphate per square metre of said fluidized bed reactor per hour (kg SO₄/m²/hr).

Preferably, the reactor further comprises a discharge conduit for periodically removing the crystallized solids from the reactor. The reactor may further comprise at least one conduit for loading calcium and at least one conduit for loading a source of carbonate.

As noted above, according to another embodiment, there is no need for external source of calcium. Carbonates can be added by means of pH increase. As the feed fluid (entering the reactor) contains bicarbonates, increase of the pH will convert the bicarbonates to carbonates.

Optionally, the reactor may include at least one conduit for loading anti-scalant to the fluid.

It is one object of the present invention to provide a process for the removal of sulphate from fluids, the process comprising passing at least one fluid comprising at least one selected from a group consisting of at least one sulphate-based compound or composition, at least one carbonate-based composition and any combination thereof through at least one fluidized bed reactor; and, loading at least one sulphate-based compound or composition to said at least one fluidized bed reactor at a rate that is greater than 1 kg of sulphate per square metre of said at least one fluidized bed reactor per hour (kg SO₄/m²/hr); thereby co-precipitating the at least one sulphate-based compound or composition and the at least one carbonate-based composition.

It is another object of the present invention to provide the process as defined above, further comprising a step of periodically removing the crystallized solids from the at least one fluidized bed reactor.

It is another object of the present invention to provide the process as defined above, further comprising a step of supersaturating the fluid within the fluidized bed.

It is another object of the present invention to provide the process as defined above, wherein the at least one sulphate-based compound or composition is calcium sulphate and the at least one at least one carbonate-based composition is calcium carbonate.

It is another object of the present invention to provide the process as defined above, wherein the process provides a loading rate of the at least one sulphate-based compound or composition in the at least one fluidized bed reactor that is greater than 10 kg of at least one sulphate-based compound or composition per square metre of said at least one fluidized bed reactor per hour (kg SO₄/m²/hr), more preferably greater than 25 kg of at least one sulphate-based compound or composition per square metre of said at least one fluidized bed reactor per hour (kg SO₄/m²/hr), especially being at least 30 kg of at least one sulphate-based compound or composition per square metre of said at least one fluidized bed reactor per hour (kg SO₄/m²/hr).

It is another object of the present invention to provide the process as defined above, wherein the process provides a maximum loading rate of at least one sulphate-based compound or composition in the at least one fluidized bed reactor of 40 kg of at least one sulphate-based compound or composition per square metre of at least one fluidized bed reactor per hour (kg SO₄/m²/hr).

It is another object of the present invention to provide the process as defined above, wherein the supersaturation level of the calcium sulphate is maintained between 100%-450%.

It is another object of the present invention to provide the process as defined above, wherein a logarithm of calcium carbonate saturation levels is maintained at between 0-2.2.

It is another object of the present invention to provide the process as defined above, wherein the flow velocity of said at least one fluid through the at least one fluidized bed reactor is at least 20 m/hr.

It is another object of the present invention to provide the process as defined above, wherein the flow velocity of the at least one fluid is in the range of about 20-about 120 m/hr.

It is another object of the present invention to provide the process as defined above, wherein the ratio of precipitated calcium carbonate to precipitated calcium sulphate is at least 0.01 (1 to 10) mass-based.

It is another object of the present invention to provide the process as defined above, further comprising step of adding at least one source of calcium.

It is another object of the present invention to provide the process as defined above, further comprising step of adding either to said fluid and/or to said at least one fluidized bed reactor at least one sulphate-based compound or composition, at least one carbonate-based composition and any combination thereof.

It is another object of the present invention to provide the process as defined above, further comprising step of increasing the pH of said at least one fluid containing at least one sulphate-based compound or composition and at least one carbonate-based composition to thereby converting bicarbonates to carbonates.

It is another object of the present invention to provide the process as defined above, wherein the source of calcium is calcium hydroxide, calcium Chloride, CaCl2 and other salts and the source of carbonate is any selected from sodium carbonate, carbon dioxide, CO2.

It is another object of the present invention to provide the process as defined above, further comprising a step of adding anti-scalant to the at least one fluid.

It is another object of the present invention to provide the process as defined above, further comprising step of recycling the at least one fluid back through the at least one fluidized bed reactor.

It is another object of the present invention to provide the process as defined above, further comprising step of recirculating the effluent stream of said at least one fluidized bed reactor back to said at least one fluidized bed reactor.

It is another object of the present invention to provide the process as defined above, stirring the fluid containing at least one sulphate-based compound or composition and at least one carbonate-based composition within said at least one fluidized bed reactor.

It is another object of the present invention to provide the process as defined above, wherein said fluid is selected from a group consisting of water, wastewater, effluents, industrial wastewater and any combination thereof.

It is another object of the present invention to provide the process as defined above, further comprising a step of periodically removing the crystallized solids that have a minimal average size of 300 micro-meter, and with more preference a minimal average size of 600 micro-meter or a minimal average size of 800 micro-meter, from the at least one fluidized bed reactor.

It is another object of the present invention to provide a fluidized bed reactor for the removal of at least one sulphate-based compound or composition from fluids, comprising:
a. at least one inlet conduit for delivering at least one fluid comprising at least one selected from a group consisting of at least one sulphate-based compound or composition, at least one carbonate-based composition and any combination thereof; and,
b. at least one loading conduit for loading at least one sulphate-based compound or composition to said fluidized bed reactor;

wherein said at least one sulphate-based compound or composition is loaded into said at least one loading conduit at a loading rate that is greater than 1 kg of at least one sulphate-based compound or composition per square metre of said fluidized bed reactor per hour (kg SO₄/m²/hr).

It is another object of the present invention to provide the fluidized bed reactor as defined above, further comprising a discharge conduit for periodically removing the crystallized solids from the fluidized bed reactor.

It is another object of the present invention to provide the fluidized bed reactor as defined above, further comprising supersaturating the fluid within the fluidized bed.

It is another object of the present invention to provide the fluidized bed reactor as defined above, wherein the at least one sulphate-based compound or composition is calcium sulphate and the carbonate is calcium carbonate.

It is another object of the present invention to provide the fluidized bed reactor as defined above, wherein the loading rate of at least one sulphate-based compound or composition into the reactor that is greater than 10 kg of at least one sulphate-based compound or composition per square metre of reactor per hour (kg SO₄/m²/hr), more preferably greater than 25 kg of at least one sulphate-based compound or composition per square metre of reactor per hour (kg SO₄/m²/hr), especially being at least 30 kg of at least one sulphate-based compound or composition per square metre of reactor per hour (kg SO₄/m²/hr).

It is another object of the present invention to provide the fluidized bed reactor as defined above, wherein the maximum loading rate of at least one sulphate-based compound or composition in the reactor is 40 kg of at least one sulphate-based compound or composition per square metre of reactor per hour (kg SO₄/m²/hr).

It is another object of the present invention to provide the fluidized bed reactor as defined above, wherein the supersaturation level of the calcium sulphate is maintained between 100%-450%.

It is another object of the present invention to provide the fluidized bed reactor as defined above, wherein a logarithm of calcium carbonate saturation levels is maintained at between 0-2.2.

It is another object of the present invention to provide the fluidized bed reactor as defined above, wherein the flow velocity of the at least one fluid through the reactor is at least 20 m/hr.

It is another object of the present invention to provide the fluidized bed reactor as defined above, wherein the flow velocity of the at least one fluid is in the range of about 20-about 120 m/hr.

It is another object of the present invention to provide the fluidized bed reactor as defined above, wherein the ratio of precipitated calcium carbonate to precipitated calcium sulphate is at least 0.1 (1 to 10).

It is another object of the present invention to provide the fluidized bed reactor as defined above, further comprising at least one conduit for loading calcium.

It is another object of the present invention to provide the fluidized bed reactor as defined above, further comprising at least one conduit for loading either to said fluid and/or to said at least one fluidized bed reactor at least one sulphate-based compound or composition, at least one carbonate-based composition and any combination thereof.

It is another object of the present invention to provide the fluidized bed reactor as defined above, wherein the source of calcium is calcium hydroxide, calcium Chloride, CaCl2 and other salts and the source of carbonate is any selected from sodium carbonate, carbon dioxide, CO2.

It is another object of the present invention to provide the fluidized bed reactor as defined above, further comprising increasing the pH of said at least one fluid containing at least one sulphate-based compound or composition and at least one carbonate-based composition to thereby converting bicarbonates to carbonates.

It is another object of the present invention to provide the fluidized bed reactor as defined above, further comprising at least one conduit for loading anti-scalant to the at least one fluid.

It is another object of the present invention to provide the fluidized bed reactor as defined above, further comprising at least one conduit for recirculating the effluent stream of said fluidized bed reactor back to said fluidized bed reactor.

It is another object of the present invention to provide the fluidized bed reactor as defined above, wherein said fluidized bed reactor is stirred for stirring said fluid containing at least one sulphate-based compound or composition and at least one carbonate-based composition within said fluidized bed reactor.

It is another object of the present invention to provide the fluidized bed reactor as defined above, wherein said conduit for loading of at least one sulphate-based compound or composition is loading of at least one selected from a group consisting of sodium sulphate, hydrogen sulphate and any combination thereof.

It is another object of the present invention to provide the fluidized bed reactor as defined above, wherein said loading of at least one sulphate-based compound or composition is loading of at least one selected from a group consisting of sodium sulphate, hydrogen sulphate and any combination thereof.

It is another object of the present invention to provide the fluidized bed reactor as defined above, wherein said fluid is selected from a group consisting of water, wastewater, effluents, industrial wastewater and any combination thereof.

### BRIEF DESCRIPTION OF THE DRAWINGS

Embodiments of the invention shall now be described, by way of example only, with reference to the accompanying drawings in which:

FIG. 1 is a schematic diagram of a fluidized bed reactor for carrying out a process according to one embodiment of the present invention.

FIG. 2 is a graph illustrating Ca loading, SO₄ loading and Calcite/Gypsum ratio Vs turbidity.

FIG. 3 is a graph illustrating SO₄ loading rate and gypsum/calcite ratio (=[calcite/gypsum]-1) projected on primary vertical axis and turbidity on secondary vertical axis Vs the test #. The red dashed line represents the turbidity limit (100 NTU) which above it the test is considered unsuccessful. The 2 tests with the highest SO₄ loading rates are marked with dotted frame, test no. 4.8, (successful) and dotted frame, test no. 4.9 (failed).

### DETAILED DESCRIPTION OF THE INVENTION

The present invention provides an improved water treatment process for improving the removal of sulphate from waste waters, such as industrial waste waters. The present invention further provides an improved water treatment process being an integral part of a desalination process. This is achieved by the adaption of a fluidized bed reactor for the co-precipitation of calcium sulphate with calcium carbonate on the fluidized crystals in the reactor. Such co-precipitation of the sulphate and carbonate has not been previously disclosed and has surprisingly been found to provide a number of advantages over the prior art methods of removing sulphates from wastewaters.

The term “crystalactor” refers herein after to a fluidized bed reactor and/or pellet reactor and/or any reactor in which the fluid (e.g., water) is treated by means of crystallisation.

The term “supersaturation” refers herein after to a solution when the concentration of a solute exceeds the concentration specified by the value of solubility at equilibrium.

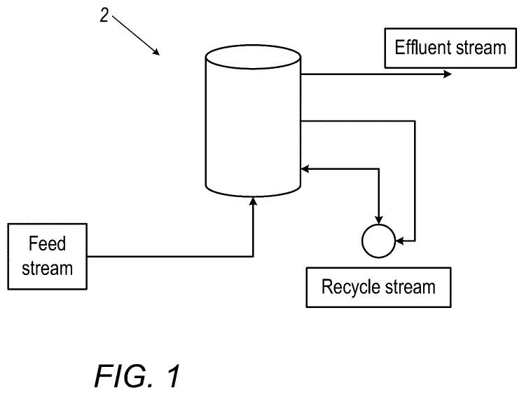

FIG. 1 of the accompanying drawing illustrates the basic components of a fluidized bed reactor. The reactor 2 is partially filled with suitable seed particles, such as sand, and the feed stream is pumped upwardly through the bed of particles to maintain the same in a state of fluidization. The seed particles are used to form crystallization sites, providing a high surface area that lowers the required energy for precipitation. The sparingly soluble salts such as calcium carbonate precipitates on the seed particles, creating salt-coated crystals. The crystals become progressively heavier causing them to sink to the bottom of the bed. Periodically, without interruption of operation of the reactor, the lower portion of the bed is discharged and fresh seed is introduced into the reactor. No filter or mechanical dewatering is required. The concentration of dry solids in the obtained crystals is more than 90% and these can be used for landfill, road building, as an animal feed additive, in cement making and other applications (for example, see Giesen A., Erwee H., Wilson R., Botha M and Fourie S., “Experience with Crystallization as Sustainable, Zero-Waste Technology for Treatment of Wastewater”, Proceedings of International Mine Water Conference (2009), Pretoria, South Africa).

Fluidized bed reactors are not used for the precipitation of calcium sulphate due to its slow crystallization kinetics. While this may be sped up by use of higher saturation conditions, this leads to homogenous precipitation (also refers to in hereinabove as crystallization) of calcium sulphate with the creation of new nuclei in the solution instead of growth on the available crystals and the production of low density solids which will require significant and difficult dewatering methods.

The present invention solves this problem by the adapting the fluidized bed reactor to perform co-precipitation of calcium sulphate and calcium carbonate. This has been found to accelerate calcium sulphate crystallization kinetics, reducing the time required for crystallization from hours to minutes. Furthermore, crystallization of the calcium sulphate can be controlled in the heterogenous zone, preventing the production of new nuclei and enabling higher density solids to be retrieved for easier disposal. However, this is not a straightforward task.

According to another embodiment of the present invention, a low concentration of anti-scalant can be also used in the process to prevent the creation of new nuclei and enable precipitation of calcium sulphate on the available crystals (pellets) in the reactor.

It has been found that co-precipitation of the sulphate and carbonate alone does not ensure heterogenous crystallization of the sulphate. It is necessary to provide particular supersaturation levels and flow rates through the reactor. The claimed process enables the loading rate of sulphate in the reactor to be up to or below 40 kg SO₄ per square meter of reactor per hour (kg SO₄/m²/hr). Loading rate is the amount of sulphate that was precipitated on the crystals/pellets in the reactor per hour per square meter of the fluidized bed reactor cross section area, a fluidized bed reactor with an advanced control system. This is substantially more than previously obtained with prior art processes that did not co-precipitate the sulphate with the carbonate, which reported loading rates of less than 1 kg of sulphate per square meter of reactor per hour (kg SO₄/m²/hr) being the norm.

It was found by the inventors of this application that such loading range results in precipitation of the calcium sulphate, CaSO₄, on the crystals in the fluidized bed reactor, (FBR). Obtaining surface crystallization (heterogeneous crystallization) a certain supersaturation ratio, close to solubility, needs to be achieved. By increasing the supersaturation ratio, homogeneous precipitation (namely, spontaneous crystallization on all available surfaces and in the solution) occurs, instead of heterogeneous crystallization. Therefore, high supersaturation ratio is not favorable.

By using antiscalant, heterogeneous precipitation is achieved at higher supersaturation ratios. In addition, by coprecipitation initiation of the crystallization process can be controlled.

To maintain sulphate loading in the required range (below 40 kg of SO₄ per square meter of the reactor per hour, kg SO₄/m²/hr), the internal recirculation may be added to the reactor (see FIG. 1). With and without recirculation, the upflow velocity should be kept in the range between 20-120 m/hr, preferable between 20-80 m²/hr (kg SO₄/m²/hr).

The ratio of precipitated calcium carbonate (calcite) to precipitated calcium sulphate (gypsum) should be at least 0.1 (1 to 10) mass-based. At lower ratio, the coprecipitation does not occur.

As described above, if the supersaturation conditions of the calcium sulphate are too high, new nuclei of the calcium sulphate are produced and the crystallization process is shifted towards undesirable homogenous crystallization. Therefore, the supersaturation of calcium sulphate is maintained below a certain supersaturation, in particular being 100-450%, preferably around 300%. The supersaturation of calcium carbonate is maintained below a certain supersaturation as well, in particular being 0-2.2 (logarithm of calcium carbonate supersaturation level), preferably around 1.0-1.5. The anti-scalant can be used to control the precipitation process on the available crystals in the reactor.

Ideally, the process works effectively without any recycling at all. However, a recycling step may be included in order to maintain the required saturation rate. This does also require an increase in the diameter of the reactor which increases the cost so an alternative more preferred solution is to add anti-scalant (scaling prevention agent) to the treated solution to extend the zone/limit of heterogenous crystallization, allowing heterogenous crystallization of the calcium sulphate at higher supersaturation conditions without the need to recirculate part of the treated solution and increase the diameter of the reactor accordingly.

Thus, it is one object of the present invention to provide a process for the removal of sulphate from fluids, the process comprising passing at least one fluid comprising at least one sulphate-based compound or composition and at least one carbonate-based composition through at least one fluidized bed reactor; and, loading at least one sulphate-based compound or composition to said at least one fluidized bed reactor at a rate that is greater than 1 kg of sulphate per square metre of said at least one fluidized bed reactor per hour (kg SO₄/m²/hr); thereby co-precipitating the at least one sulphate-based compound or composition and the at least one carbonate-based composition.

It is another object of the present invention to provide the process as defined above, further comprising a step of periodically removing the crystallized solids from the at least one fluidized bed reactor.

It is another object of the present invention to provide the process as defined above, further comprising a step of supersaturating the fluid within the fluidized bed.

It is another object of the present invention to provide the process as defined above, wherein the at least one sulphate-based compound or composition is calcium sulphate and the at least one at least one carbonate-based composition is calcium carbonate.

It is another object of the present invention to provide the process as defined above, wherein the process provides a loading rate of the at least one sulphate-based compound or composition in the at least one fluidized bed reactor that is greater than 10 kg of at least one sulphate-based compound or composition per square metre of said at least one fluidized bed reactor per hour (kg SO₄/m²/hr), more preferably greater than 25 kg of at least one sulphate-based compound or composition per square metre of said at least one fluidized bed reactor per hour (kg SO₄/m²/hr), especially being at least 30 kg of at least one sulphate-based compound or composition per square metre of said at least one fluidized bed reactor per hour (kg SO₄/m²/hr).

It is another object of the present invention to provide the process as defined above, wherein the process provides a maximum loading rate of at least one sulphate-based compound or composition in the at least one fluidized bed reactor of 40 kg of at least one sulphate-based compound or composition per square metre of at least one fluidized bed reactor per hour (kg SO₄/m²/hr).

It is another object of the present invention to provide the process as defined above, wherein the supersaturation level of the calcium sulphate is maintained between 100%-450%.

It is another object of the present invention to provide the process as defined above, wherein a logarithm of calcium carbonate saturation levels is maintained at between 0-2.2.

It is another object of the present invention to provide the process as defined above, wherein the flow velocity of said at least one fluid through the at least one fluidized bed reactor is at least 20 m/hr.

It is another object of the present invention to provide the process as defined above, wherein the flow velocity of the at least one fluid is in the range of about 20-about 120 m/hr.

It is another object of the present invention to provide the process as defined above, wherein the ratio of precipitated calcium carbonate to precipitated calcium sulphate is at least 0.01 (1 to 10) mass-based.

It is another object of the present invention to provide the process as defined above, further comprising step of adding at least one source of calcium.

It is another object of the present invention to provide the process as defined above, further comprising step of adding either to said fluid and/or to said at least one fluidized bed reactor at least one sulphate-based compound or composition, at least one carbonate-based composition and any combination thereof.

It is another object of the present invention to provide the process as defined above, further comprising step of increasing the pH of said at least one fluid containing at least one sulphate-based compound or composition and at least one carbonate-based composition to thereby converting bicarbonates to carbonates.

It is another object of the present invention to provide the process as defined above, wherein the source of calcium is calcium hydroxide, calcium Chloride, CaCl2 and other salts and the source of carbonate is any selected from sodium carbonate, carbon dioxide, CO2.

It is another object of the present invention to provide the process as defined above, further comprising a step of adding anti-scalant to the at least one fluid.

It is another object of the present invention to provide the process as defined above, further comprising step of recycling the at least one fluid back through the at least one fluidized bed reactor.

It is another object of the present invention to provide the process as defined above, further comprising step of recirculating the effluent stream of said at least one fluidized bed reactor back to said at least one fluidized bed reactor.

It is another object of the present invention to provide the process as defined above, stirring the fluid containing at least one sulphate-based compound or composition and at least one carbonate-based composition within said at least one fluidized bed reactor.

It is another object of the present invention to provide the process as defined above, wherein said fluid is selected from a group consisting of water, wastewater, effluents, industrial wastewater and any combination thereof.

It is another object of the present invention to provide a fluidized bed reactor for the removal of at least one sulphate-based compound or composition from fluids, comprising,
c. at least one inlet conduit for delivering at least one fluid comprising at least one sulphate-based compound or composition and at least one carbonate-based composition; and,
d. at least one loading conduit for loading at least one sulphate-based compound or composition to said fluidized bed reactor;
wherein said at least one sulphate-based compound or composition is loaded into said at least one loading conduit at a loading rate that is greater than 1 kg of at least one sulphate-based compound or composition per square metre of said fluidized bed reactor per hour (kg SO₄/m²/hr).

It is another object of the present invention to provide the fluidized bed reactor as defined above, further comprising a discharge conduit for periodically removing the crystallized solids from the fluidized bed reactor.

It is another object of the present invention to provide the fluidized bed reactor as defined above, further comprising supersaturating the fluid within the fluidized bed.

It is another object of the present invention to provide the fluidized bed reactor as defined above, wherein the at least one sulphate-based compound or composition is calcium sulphate and the carbonate is calcium carbonate.

It is another object of the present invention to provide the fluidized bed reactor as defined above, wherein the loading rate of at least one sulphate-based compound or composition into the reactor that is greater than 10 kg of at least one sulphate-based compound or composition per square metre of reactor per hour (kg SO₄/m²/hr), more preferably greater than 25 kg of at least one sulphate-based compound or composition per square metre of reactor per hour (kg SO₄/m²/hr), especially being at least 30 kg of at least one sulphate-based compound or composition per square metre of reactor per hour (kg SO₄/m²/hr).

It is another object of the present invention to provide the fluidized bed reactor as defined above, wherein the maximum loading rate of at least one sulphate-based compound or composition in the reactor is 40 kg of at least one sulphate-based compound or composition per square metre of reactor per hour (kg SO₄/m²/hr).

It is another object of the present invention to provide the fluidized bed reactor as defined above, wherein the supersaturation level of the calcium sulphate is maintained between 100%-450%.

It is another object of the present invention to provide the fluidized bed reactor as defined above, wherein a logarithm of calcium carbonate saturation levels is maintained at between 0-2.2.

It is another object of the present invention to provide the fluidized bed reactor as defined above, wherein the flow velocity of the at least one fluid through the reactor is at least 20 m/hr.

It is another object of the present invention to provide the fluidized bed reactor as defined above, wherein the flow velocity of the at least one fluid is in the range of about 20-about 120 m/hr.

It is another object of the present invention to provide the fluidized bed reactor as defined above, wherein the ratio of precipitated calcium carbonate to precipitated calcium sulphate is at least 0.1 (1 to 10).

It is another object of the present invention to provide the fluidized bed reactor as defined above, further comprising at least one conduit for loading calcium.

It is another object of the present invention to provide the fluidized bed reactor as defined above, further comprising at least one conduit for loading either to said fluid and/or to said at least one fluidized bed reactor at least one sulphate-based compound or composition, at least one carbonate-based composition and any combination thereof.

It is another object of the present invention to provide the fluidized bed reactor as defined above, wherein the source of calcium is calcium hydroxide, calcium Chloride, CaCl2 and other salts and the source of carbonate is any selected from sodium carbonate, carbon dioxide, CO2.

It is another object of the present invention to provide the fluidized bed reactor as defined above, further comprising increasing the pH of said at least one fluid containing at least one sulphate-based compound or composition and at least one carbonate-based composition to thereby converting bicarbonates to carbonates.

It is another object of the present invention to provide the fluidized bed reactor as defined above, further comprising at least one conduit for loading anti-scalant to the at least one fluid.

It is another object of the present invention to provide the fluidized bed reactor as defined above, further comprising at least one conduit for recirculating the effluent stream of said fluidized bed reactor back to said fluidized bed reactor.

It is another object of the present invention to provide the fluidized bed reactor as defined above, wherein said fluidized bed reactor is stirred for stirring said fluid containing at least one sulphate-based compound or composition and at least one carbonate-based composition within said fluidized bed reactor.

It is another object of the present invention to provide the fluidized bed reactor as defined above, wherein said conduit for loading of at least one sulphate-based compound or composition is loading of at least one selected from a group consisting of sodium sulphate, hydrogen sulphate and any combination thereof.

It is another object of the present invention to provide the fluidized bed reactor as defined above, wherein said loading of at least one sulphate-based compound or composition is loading of at least one selected from a group consisting of sodium sulphate, hydrogen sulphate and any combination thereof.

It is another object of the present invention to provide the fluidized bed reactor as defined above, wherein said fluid is selected from a group consisting of water, wastewater, effluents, industrial wastewater and any combination thereof.

### Examples

The concept of the present invention was tested and the evaluation of SO₄ loading rate at different conditions was assessed.

During the testing, a different set of parameters was chosen with the goal to increase gradually the SO4 loading rate to the crystalactor (a fluidized-bed reactor) and decrease Calcite/Gypsum ratio (CaCO3/CaSO₄ ratio) being precipitated. As will be demonstrated hereinbelow, SO₄ loading rate reached 29.1 kg SO4/m2/hr at calcite/gypsum (CaCO3/CaSO₄) mass-ratio of 0.12.

Thus, the objectives and their matching KPIs of the test were:

| # | Objectives | KPIs |
|---|---|---|
| 1 | Validation of the possibility of sulfate removal in | Effluent turbidity <100 NTU |
| | Crystalactor by coprecipitation of gypsum with | More than 80% of removed salts by |
| | calcite. | heterogenous precipitation on pellets |
| 2 | Evaluation of the maximum sulfate loading in the | Measured loading rate within +−30% of the |
| | Crystalactor for different calcite to gypsum | design value of the test |
| | precipitation ratios | |

During each test, several samples were taken during day for analyses in internal lab, and few samples each week were sent to external laboratory.

During the testing. 2 reactors sizes were used (20.3 mm and 50 mm). The following table summarizes all tests performed and the measured parameters:

| | SO₄ loading | Ca loading | Calcite/ | Residual | |
|---|---|---|---|---|---|
| FBR [symbol] | [kg/m²/hr] | [kg/m²/hr] | gypsum | antiscalant | Turbidity |
| 20.3 mm | — | 4.41 | — | — | 22 |
| crystalactor | 8.57 | 2.94 | 0.478 | — | 623 |
| | 7.04 | 2.94 | 0.015 | — | 787 |
| | 0.41 | 6.07 | 20.97 | — | 49 |
| | 1.17 | 6.35 | 4.99 | — | 16.7 |
| | 2.29 | 8.2 | 3.76 | — | 16 |
| | 7.94 | 9.88 | 0.85 | — | 27 |
| | 8.05 | 9.73 | 0.78 | — | 37 |
| | 9.18 | 7.3 | 0.22 | — | 21.7 |
| | 8.61 | 6.31 | 0.12 | — | 5.8 |
| | 9.46 | 5.23 | 0.075 | — | 2.95 |
| | 13.8 | 9.19 | 0.083 | 0.182 | 2.8 |
| 50 mm | — | 4.09 | — | — | 460 |
| crystalactor | 13.86 | 8.12 | 0.1 | — | 237 |
| | 2.83 | 2.85 | 0.72 | 0.072 | 28.1 |
| | 6.51 | 4.89 | 0.52 | 0.074 | 12.1 |
| | 4.72 | 3.91 | 0.2 | 0.141 | 10.6 |
| | 11.4 | 3.58 | 0.11 | 0.052 | 12.7 |
| | 14.73 | 10.01 | 0.11 | 0.087 | 6.7 |
| | 22.11 | 13.04 | 0.16 | 0.094 | 24.1 |
| | 24.06 | 18.5 | 0.33 | 0.02 | 12.1 |
| | 29.07 | 15.19 | 0.12 | 0.028 | 22.4 |
| | 32.34 | 14.88 | 0.024 | 0 | 543* |
| | 22.05 | 14.48 | 0.34 | 0 | 79.5 |
| | — | — | — | — | — |
| | — | — | — | 0.06 | 27.2 |
| | 8.4 | 2.66 | 0.752 | — | 251 |
| | 18.5 | 5.69 | 0.126 | 1.2 | 123 |
| | 16.01 | 7.56 | 0.128 | 0.5 | 62.3 |
| | 7.6** | 3.09 | 0.067 | 1.95 | 82 |

[symbol]

indicates data missing or illegible when filed

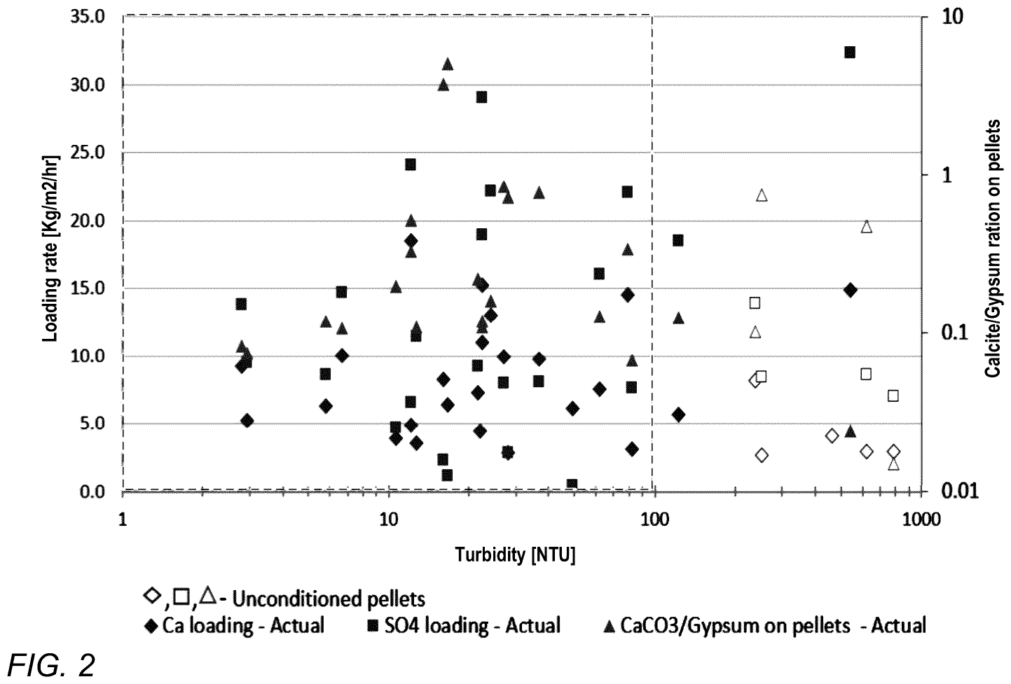

Reference is now made to FIG. 2 illustrating the variety of conditions in which the system worked with relatively low turbidity. Each test is represented by 3 points one above the other (Ca loading, SO4 loading and calcite/gypsum ratio).

As seen in FIG. 2, turbidity was kept below 50 NTU in the majority of the tests, and below 100 NTU in almost all tests. Most of the values above 100 NTU are due to significant amount of unconditioned bed in crystalactor (the fluidized bed reactor).

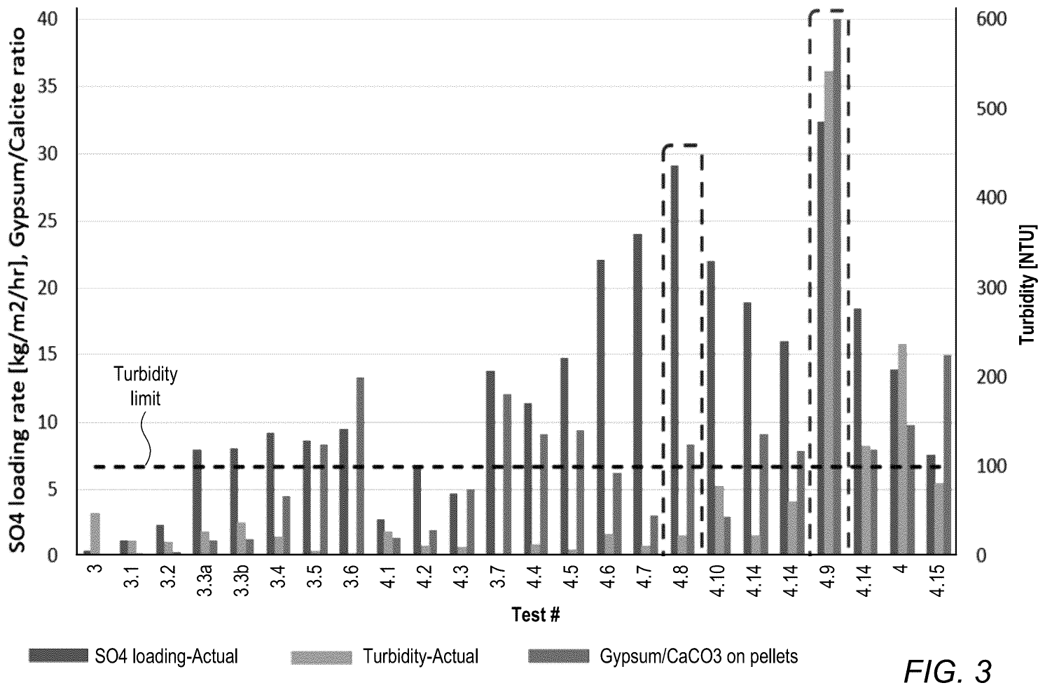

Reference is now made to FIG. 3 illustrating SO4 loading rates, gypsum/calcite ratio and turbidity of all the tests performed. In this figure the ratio of the salts is opposite compared to the rest of report (gypsum/calcite and not calcite/gypsum) form graphical reasons. The red dashed line represents the turbidity limit (100 NTU) which above it the test is considered unsuccessful.

As seen in the figure, the maximal SO4 loading rate obtained during the pilot was in test no. 4.8 (marked in doted line). In that test the SO4 loading rate was 29.1 kg SO4/m2/hr at gypsum/calcite ratio of 8.3 (calcite/gypsum ratio of 0.12). However, since the test with higher SO₄ loading rate, test no. 4.9 (marked in doted line) which failed due to high turbidity had gypsum/calcite ratio of 41.6 (calcite/gypsum ratio 0.024), more than 4 times bigger than test 4.8. The critical factor caused the homogenous precipitation was more likely the gypsum/calcite ratio.

As seen in the above:
A strong positive correlation between sulfate loading & sulfate removal and strong negative correlation between calcite/gypsum ratio & sulfate removal was observed. This means increase of loading (up to 10 kg SO4/m2/hr) or reducing dosing of alkalinity doesn't harm the process of SO4 removal.
The turbidity was not affected by increase of loadings or by other parameters, thus the limit of SO4 loading can be higher than 10 kg SO4/m2/hr.

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, and method steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and sub-combinations possible of the group are intended to be individually included in the disclosure. When a compound is described herein such that a particular isomer, enantiomer or diastereomer of the compound is not specified, for example, in a formula or in a chemical name, that description is intended to include each isomer and enantiomer of the compound described individually or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein. The term “about” refers to any value being lower or greater than 20% of the defined measure.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

1. A process for the removal of sulphate from fluids, the process comprising passing at least one fluid comprising at least one selected from a group consisting of at least one sulphate-based compound or composition, at least one carbonate-based composition and any combination thereof through at least one fluidized bed reactor; and, loading at least one sulphate-based compound or composition to said at least one fluidized bed reactor at a rate that is greater than 1 kg of sulphate per square metre of said at least one fluidized bed reactor per hour (kg SO₄/m²/hr); thereby co-precipitating the at least one sulphate-based compound or composition and the at least one carbonate-based composition.

2. The process according to claim 1, further comprising a step of periodically removing the crystallized solids from the at least one fluidized bed reactor.

3. The process according to claim 1, further comprising a step of supersaturating the fluid within the fluidized bed.

4. The process according to claim 1, wherein the at least one sulphate-based compound or composition is calcium sulphate and the at least one at least one carbonate-based composition is calcium carbonate.

5. The process according to claim 1, wherein the process provides a loading rate of the at least one sulphate-based compound or composition in the at least one fluidized bed reactor that is greater than 10 kg of at least one sulphate-based compound or composition per square metre of said at least one fluidized bed reactor per hour (kg SO₄/m²/hr), more preferably greater than 25 kg of at least one sulphate-based compound or composition per square metre of said at least one fluidized bed reactor per hour (kg SO₄/m²/hr), especially being at least 30 kg of at least one sulphate-based compound or composition per square metre of said at least one fluidized bed reactor per hour (kg SO₄/m²/hr).

6. The process according to claim 5, wherein the process provides a maximum loading rate of at least one sulphate-based compound or composition in the at least one fluidized bed reactor of 40 kg of at least one sulphate-based compound or composition per square metre of at least one fluidized bed reactor per hour (kg SO₄/m²/hr).

7. The process according to claim 4, wherein the saturation level of the calcium sulphate is maintained between 100%-450%.

8. The process according to claim 4, wherein a logarithm of calcium carbonate saturation levels is maintained at between 0-2.2.

9. The process according to claim 1, wherein the flow velocity of said at least one fluid through the at least one fluidized bed reactor is at least 20 m/hr.

10. The process according to claim 9, wherein the flow velocity of the at least one fluid is in the range of about 20-about 120 m/hr.

11. The process according to claim 3, wherein the ratio of precipitated calcium carbonate to precipitated calcium sulphate is at least 0.01 (1 to 10) mass-based.

12. The process according to claim 1, further comprising at least one step selected from a group comprising of (a) adding either to said fluid and/or to said at least one fluidized bed reactor at least one source of calcium; (b) adding either to said fluid and/or to said at least one fluidized bed reactor at least one sulphate-based compound or composition, at least one carbonate-based composition and any combination thereof; (c) increasing the pH of said at least one fluid containing at least one sulphate-based compound or composition and at least one carbonate-based composition to thereby converting bicarbonates to carbonates; (d) adding anti-scalant to the at least one fluid; (e) recycling the at least one fluid back through the at least one fluidized bed reactor; (f) recirculating the effluent stream of said at least one fluidized bed reactor back to said at least one fluidized bed reactor; (g) stirring the fluid containing at least one sulphate-based compound or composition and at least one carbonate-based composition within said at least one fluidized bed reactor; and any combination thereof.

13. The process according to claim 12, wherein the source of calcium is calcium hydroxide, calcium Chloride, CaCl2 and other salts; further wherein the source of carbonate is any selected from sodium carbonate, carbon dioxide, CO2.

14. The process according to claim 1, wherein said fluid is selected from a group consisting of water, wastewater, effluents, industrial wastewater and any combination thereof.

15. The process according to claim 1, wherein said loading of at least one sulphate-based compound or composition is loading of at least one selected from a group consisting of sodium sulphate, hydrogen sulphate and any combination thereof.

16. The process according to claim 1, further comprising a step of periodically removing the crystallized solids that have a minimal average size of 300 micro-meter, and with more preference a minimal average size of 600 micro-meter or a minimal average size of 800 micro-meter, from the at least one fluidized bed reactor.

17. A fluidized bed reactor for the removal of at least one sulphate-based compound or composition from fluids, comprising,
a. at least one inlet conduit for delivering at least one fluid comprising at least one selected from a group consisting of at least one sulphate-based compound or composition, at least one carbonate-based composition and any combination thereof; and,
b. at least one loading conduit for loading at least one sulphate-based compound or composition to said fluidized bed reactor;
wherein said at least one sulphate-based compound or composition is loaded into said at least one loading conduit at a loading rate that is greater than 1 kg of at least one sulphate-based compound or composition per square metre of said fluidized bed reactor per hour (kg SO₄/m²/hr).

18. The fluidized bed reactor according to claim 17, further comprising at least one selected from a group comprising of (a) a discharge conduit for periodically removing the crystallized solids from the fluidized bed reactor; (b) means for supersaturating the fluid within the fluidized bed; (c) at least one conduit for loading either to said fluid and/or to said at least one fluidized bed reactor at least one sulphate-based compound or composition, at least one carbonate-based composition and any combination thereof; (d) means for increasing the pH of said at least one fluid containing at least one sulphate-based compound or composition and at least one carbonate-based composition to thereby converting bicarbonates to carbonates; (e) at least one conduit for loading anti-scalant to the at least one fluid; (f) at least one conduit for recirculating the effluent stream of said fluidized bed reactor back to said fluidized bed reactor; and any combination thereof.

19. The fluidized bed reactor according to claim 17, wherein at least one of the following is held true (a) the at least one sulphate-based compound or composition is calcium sulphate and the carbonate is calcium carbonate; (b) the loading rate of at least one sulphate-based compound or composition into the reactor that is greater than 10 kg of at least one sulphate-based compound or composition per square metre of reactor per hour (kg SO₄/m²/hr), more preferably greater than 25 kg of at least one sulphate-based compound or composition per square metre of reactor per hour (kg SO₄/m²/hr), especially being at least 30 kg of at least one sulphate-based compound or composition per square metre of reactor per hour (kg SO₄/m²/hr); (c) the maximum loading rate of at least one sulphate-based compound or composition in the reactor is 40 kg of at least one sulphate-based compound or composition per square metre of reactor per hour (kg SO₄/m²/hr); (d) the saturation level of the calcium sulphate is maintained between 0%-450%; (e) a logarithm of calcium carbonate saturation levels is maintained at between 0-2.2; (f) the flow velocity of the at least one fluid through the reactor is at least 20 m/hr; (g) the flow velocity of the at least one fluid is in the range of about 20-about 120 m/hr; and any combination thereof.

20. The fluidized bed reactor according to claim 17, wherein at least one of the following is held true (a) the ratio of precipitated calcium carbonate to precipitated calcium sulphate is at least 0.1 (1 to 10); (b) the fluidized bed reactor further comprising at least one conduit for loading calcium; wherein the source of calcium is calcium hydroxide, calcium Chloride, CaCl2 and other salts; further wherein the source of carbonate is any selected from sodium carbonate, carbon dioxide, CO2; (c) said fluidized bed reactor is stirred for stirring said fluid containing at least one sulphate-based compound or composition and at least one carbonate-based composition within said fluidized bed reactor; (d) said conduit for loading of at least one sulphate-based compound or composition is loading of at least one selected from a group consisting of sodium sulphate, hydrogen sulphate and any combination thereof; (e) said fluid is selected from a group consisting of water, wastewater, effluents, industrial wastewater and any combination thereof; (f) the crystallized solids characterized by having minimal average size of at least 300 micro-meter are periodically removed; and any combination thereof.
